(19) United States
(12) Patent Application Publication
(10) Pub. No.: US 2016/0262427 A1
(43) Pub. Date: Sep. 15, 2016

(54) FORMULA FEED CONTAINING BIOGAS RESIDUES FOR CHICKENS

(71) Applicant: ZHEJIANG AGRICULTURAL AND FORESTRY UNIVERSITY, Linan, Zhejiang (CN)

(72) Inventors: FANGBO YU, Linan, Zhejiang (CN); SHENGDAO SHAN, Linan, Zhejiang (CN); LINPIN LUO, Linan, Zhejiang (CN); ZHENGQIAN YE, Linan, Zhejiang (CN); LIBO GUAN, Linan, Zhejiang (CN)

(21) Appl. No.: 14/401,515

(22) PCT Filed: Apr. 2, 2014
(86) PCT No.: PCT/CN2014/074585

§ 371 Date: Nov. 15, 2014

(30) Foreign Application Priority Data
May 24, 2013 (CN) 201310204031.4

(51) Int. Cl. A23K 10/38; A23K 10/30; A23K 50/75

(52) U.S. Cl. CPC A23K 10/38; A23K 50/75; A23K 10/30

(57) ABSTRACT

The present invention belongs to the field of feed, and particularly relates to formula feed containing biogas residues for chickens. The formula feed for chickens is prepared by mixing a component A and a component B, wherein the component A makes up 17%-37.5% of the total weight. The component A is prepared by mixing the following raw materials in parts by weight: 20-50 parts of biogas residues, 15-28 parts of radix astragali residues, 3-6 parts of purple perilla, 4-8 parts of eucommia leaves, 3-8 parts of purslane and 1-2 parts of premix. The biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use. The component B is prepared by mixing the following raw materials in parts by weight: 48-52 parts of corn, 10-12 parts of soybean meal, 1.2-1.5 parts of calcium hydrophosphate, 1.2-1.3 parts of rock flour and 0.1-0.3 parts of salt. The scientifically-formulated and nutrient-rich feed composition enhances the immunity of chicks, decreases the risk of various diseases or infections during the feeding process, and reduces the use of drugs.

### TECHNICAL FIELD OF THE INVENTION

The present invention belongs to the field of feed, and particularly relates to formula feed containing biogas residues for chickens.

### BACKGROUND OF THE INVENTION

As resulting products from anaerobic fermentation of organic wastes, biogas residues are regarded as one of valuable resources and rich in soluble inorganic salt nutrient substances and various biochemical products (for example, nitrogen, phosphorus, potassium, boron, copper, manganese, calcium, zinc and other microelements, and various amino acids), and are thus prone to uptake by living beings and crops. In addition, the biogas residues, containing 23.5-35.8% of protein and vitamin B₁₂ of 17.6 mg/kg (dry weight), may be used as feed after processed, with considerable nutritive and economic benefits.

The biogas residues, nutrients contained in which are not only nutrient elements necessary for the growth of crops but also main nutrient substances in feed used for livestock feeding and aquaculture, are somewhat valuable in resource utilization. Making full use of biogas residues eases the crisis of resources to a certain extent and makes waste profitable, as well as brings considerable economic and social benefits while reducing ambient pollution burden. Recently, some large wineries and alcohol plants (e.g., factories in Mianzhu city in Sichuan and Linyi city in Shandong, etc.) have invested heavily in anaerobic fermentation facilities, and have constructed a number of large-scale biogas projects using distillers' grains as raw materials by actively utilizing the biogas anaerobic fermentation technology, with considerable yield of biogas residues. However, these resulting products from fermentation have not been utilized reasonably and effectively, thereby resulting in the waste of resources. At present, as the overall supply-demand relationship in the field of feed resources presents the characteristics of concentrated feed shortage, protein feed shortage, green feed shortage, and insufficiency of total yield and so forth, biogas residues which have not been widely applied in the field of feed need to be urgently exploited and utilized.

### SUMMARY OF THE INVENTION

An objective of the present invention is to provide formula feed containing biogas residues for chickens, which has adequate raw materials and nutrient-rich components in the raw materials and improves the utilization ratio of resources.

To solve the technical problem, the present invention employs the following technical solutions.

Formula feed containing biogas residues for chickens is provided, being prepared by mixing a component A and a component B, wherein the component A makes up 17%-37.5% of the total weight;

the component A is prepared by mixing the following raw materials in parts by weight: 20-50 parts of biogas residues, 15-28 parts of radix astragali residues, 3-6 parts of purple perilla, 4-8 parts of eucommia leaves, 3-8 parts of purslane, and 1-2 parts of premix; the biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use; and

the component B is prepared by mixing the following raw materials in parts by weight: 48-52 parts of corn, 10-12 parts of soybean meal, 1.2-1.5 parts of calcium hydrophosphate, 1.2-1.3 parts of rock flour, and 0.1-0.3 parts of salt.

Preferably, the component A makes up 22%-30% of the total weight.

In the present invention, as wastes respectively from biogas anaerobic fermentation and traditional Chinese medicine production, the biogas residues and radix astragali residues are easy to get, low in price and cost, and thus suitable for large-scale production. The raw materials of the feed conform to the national standards for the feed industry. The premix, providing minerals and vitamins for the feed, may be purchased from the market. As the resulting products from anaerobic fermentation and free of parasites and hazardous substances, the biogas residues are highly safe as feed additives. The radix astragali residues still contain a certain amount of astragaloside as well as saponins, flavone, polysaccharide, amino acids, microelements and the like, which, when constituting the component A of the present invention together with the biogas residues and other components, play a role of complementation and regulation in the aspect of nutrients. Meanwhile, in this way, the utilization of two kinds of wastes is realized.

Tender and nutrient-rich leaves of purple perilla contain protein, fat, soluble sugar, dietary fiber, carotene, vitamin B1, vitamin B2, vitamin C, potassium, calcium, phosphorus, iron, manganese, selenium and other components. In addition, the leaves contain volatile oil containing perillaldehyde, perillyl alcohol, menthone, menthol, eugenol, egomaketon and the like, and thus have a peculiar fragrance and preservative effects. It was found by studies that, purple perilla with uniform parts has a good anticancer effect, especially its leaves. Oleanolic acid is an efficient natural anticancer agent which protects against tumors and also has anti-inflammatory, sedative, cardiotonic, diuresis, immunity supporting, anti-hyperlipemia and growth of cancer cells inhibition properties.

The eucommia leaves contain chlorogenic acid having a broad range of antibacterial activities.

The purslane, containing protein, fat, various vitamins, minerals and other nutrients, is edible and has medicinal benefitis. The purslane contains vitamin A like substances which can maintain physiological functions of epithelial tissues including skin, mucosa, cornea and the like. As a kind of wild vegetables, the purslane is easy to get and effective in antibacterial activities, and works well in preventing and treating enteritis, coccidium and the like.

In the present invention, the addition of radix astragali residues and purple perilla may effectively enhance the immunity of chicks, thereby avoiding the waste of drug dregs and reducing the use of medicaments in feed for chicks. The further formulation of eucommia leaves and purslane in proportion makes the feed composition have broad-spectrum anti-inflammatory capabilities, thereby greatly enhancing the immunity of chicks and reducing the risk of various infections and diseases. Meanwhile, the active substances of each component are accumulated in chicken muscle tissues, so that the content of fatty acids and amino acids in chicken muscle is improved, and the nutritive value and taste of chicken muscle are both improved.

Researches show that both the disease resistance and survival rate of chicks cannot be improved when any one of the raw materials in the component A is fed alone. However, in the present invention, when the component A as an active component is mixed with the component B to form formula feed for chickens, the components in the component A are mixed properly in proportion, so that the active constituents in each component are coordinated with each other to generate a balance between the nutrient substances; moreover, the active constituents are uniform in content, diverse, and significantly effective in increasing the survival rate of chicks. Consequently, no injection of immune drugs is required for chicks fed by the feed provided by the present invention, and thus, resistance to drugs, drug residues and other problems will be avoided.

Preferably, the component A in the formula feed containing biogas residues for chickens is prepared by mixing the following raw materials in parts by weight: 48 parts of biogas residues, 25 parts of radix astragali residues, 6 parts of purple perilla, 8 parts of eucommia leaves, 6 parts of purslane and 1 part of premix.

Preferably, the component A in the formula feed containing biogas residues for chickens is prepared by mixing the following raw materials in parts by weight: 37 parts of biogas residues, 28 parts of radix astragali residues, 4 parts of purple perilla, 6 parts of eucommia leaves, 8 parts of purslane and 1 part of premix.

A method for preparing formula feed containing biogas residues for chickens is provided, including the following steps of:

a. mixing in proportion and then crushing the purple perilla, eucommia leaves and purslane, controlling the granularity below 10 mm, and baking or air-drying until the water content is lower than 12%;

b. mixing the mixture obtained in step a with the biogas residues, radix astragali residues and the premix to obtain the component A; and

c. mixing the component A with the component B in proportion to obtain the product, where the component B is mixed in proportion.

Preferably, the preparation method further includes the step of: drying, extruding and granulating the product.

An application of the formula feed containing biogas residues for chickens in manufacturing feed for enhancing the immunity of poultry. The present invention has the following beneficial effects: by feeding chicks with the feed composition provided by the present invention, not only the conventional feed is saved, but also the quantity of drugs and the cost of feed may be both effectively reduced. The scientifically-formulated and nutrient-rich feed composition enhances the immunity of chicks, decreases the risk of various diseases or infections during the feeding process, and reduces the use of drugs.

### DETAILED DESCRIPTION OF THE INVENTION

The technical solutions of the present invention will be further described as below with reference to specific embodiments. It should be understood that the implementation of the present invention is not limited to the following embodiments, and any form of alternations and/or changes made to the present invention shall fall into the protection scope of the present invention.

In the present invention, unless otherwise specifically stated, all the part and percentage are units of weight, and all equipment and raw materials may be purchased from the market or common in the industry. The biogas residues as used in the following embodiments are resulting products from anaerobic fermentation of distillers' grains left by wineries or alcohol plants brewing wines using cassava or sweet potatoes as raw materials, and are then moisture removed by mechanical extrusion for later use. The pH of the biogas slurry fluctuates from 6.5 to 7.5. The premix may be generally purchased from the market. In the following embodiments, per kilogram of the premix contains 1500 IU of vitamin A, 200 IU of vitamin D3, 10 IU of vitamin E, 0.5 mg of vitamin K3, 1.8mg of thiamine, 3.6 mg of riboflavin, 10 mg of pantothenic acid, 27 mg of nicotinic acid, 3 mg of pyridoxine, 0.15 mg of biotin, 1300 mg of choline, 0.55 mg of folic acid, 9 mg of vitamin B12, 8 mg of microelement copper, 0.35 mg of iodine, 80 mg of iron, 60 mg of manganese, 40 mg of zinc and 0.15 mg of selenium.

### Embodiments 1-4

The biogas residues are oriented from large-scale anaerobic fermentation equipment normal in both operation and yield by using distillers' grains as raw materials. The pH of the biogas slurry is within a range of 6.5 to 7.5. The thoroughly decomposed biogas residues charged and discharged every day are moisture removed by mechanical extrusion, then uniformly paved in a thickness of 5-10 cm, dried by exposure to the sun and finally crushed by a crusher for later use. The results of testing show the constituents of the biogas residues, referring to Table 1.

TABLE 1
Constituents of biogas residues

| | Organic | Total | Total | Total |
|---|---|---|---|---|
| | matter | nitrogen | phosphorus | potassium |
| Sample | (%) | (%) | (%) | (%) |
| Biogas residues | 36.2-49.9 | 0.78-1.61 | 0.3-0.71 | 0.61-1.29 |

Formula feed containing biogas residues for chickens is provided, being prepared by mixing a component A and a component B. The component A is prepared by mixing the raw materials as shown in Table 2, and the component B is prepared by mixing the raw materials as shown in Table 3. The component A makes up 25% of the total weight.

The radix astragali residues are crushed and dried in advance.

TABLE 2
Proportion of raw materials of component a (unit: kg)

| Raw | Embodiment | Embodiment | Embodiment | Embodiment |
|---|---|---|---|---|
| material | 1 | 2 | 3 | 4 |
| Biogas | 48.0 | 37 | 20.8 | 50.0 |
| residues | | | | |
| Radix | 25.0 | 28.0 | 18.6 | 15.0 |
| astragali | | | | |
| residues | | | | |
| Purple perilla | 6.0 | 4.0 | 3.5 | 3.0 |
| Eucommia | 8.0 | 6.0 | 4.0 | 5.0 |
| leaves | | | | |
| Purslane | 6.0 | 8.0 | 3.5 | 3.0 |
| Premix | 1.0 | 1.0 | 2.0 | 1.0 |

TABLE 3
Proportion of raw materials of component b (unit: kg)

| Raw | Embodiment | Embodiment | Embodiment | Embodiment |
|---|---|---|---|---|
| material | 1 | 2 | 3 | 4 |
| Corn | 48.0 | 50 | 50.8 | 52.0 |
| Soybean meal | 10.0 | 12.0 | 11.6 | 10.0 |
| Calcium | 1.5 | 1.5 | 1.2 | 1.2 |
| hydro phosphate | | | | |
| Rock flour | 1.2 | 1.3 | 1.3 | 1.2 |
| Salt | 0.2 | 0.2 | 0.1 | 0.3 |

The following preparation steps are included:

a. mixing according to the proportion as shown in Table 2 and then crushing the purple perilla, eucommia leaves and purslane, controlling the granularity below 10mm, and baking or air-drying until the water content is lower than 12%;

b. mixing the mixture obtained in step a with the biogas residues, radix astragali residues and the premix to obtain the component A, and mixing the raw materials of the component B according to the proportion as shown in Table 3 to obtain the component B;

c. mixing the component A with the component B in proportion; and

d. drying, extruding and granulating the mixture obtained in step c, and then packaging to obtain the product.

### Embodiment 5

Formula feed containing biogas residues for chickens is provided, being prepared by mixing the component A and the component B as described in Embodiment 1, where the component A makes up 17% of the total weight.

### Embodiment 6

Formula feed containing biogas residues for chickens is provided, being prepared by mixing the component A and the component B as described in Embodiment 1, where the component A makes up 37.5% of the total weight.

Animal testing: chick feeding experiment

Healthy chicks were prepared and then randomly divided into a control group and a test group, each having 25 chicks, and this experiment was repeated twice (totally, 150 chicks). The chicks in the test group were fed with the formula feed containing biogas residues for chickens as prepared in Embodiment 1, while the chicks in the control group were fed with conventional feed for chickens purchased from the market (components include 43.63% of corn, 7% of bran, 8.0% of wheat, 24.5% of soybean meal, 11% of fine rice bran, 0.37% of salt, 0.15% of methionine, 1.9% of calcium hydrophosphate, 0.45% of lime mineral flour, and 3.0% of premix).

This experiment lasted for 30 days. The results of this experiment refer to Table 4 and Table 5.

TABLE 4
Influence of the feed composition of the
present invention on the growth of chicks

| Item | Control group | Test group |
|---|---|---|
| Average weight per chick (kg) | 3.13 ± 0.79 | 3.51 ± 0.92 * |
| Feed conversion ratio | 2.28 ± 0.05 | 2.04 ± 0.10 * |
| Survival rate (%) | 91.42 ± 0.09 | 99.13 ± 0.12 * |
| Abdominal fat percentage (%) | 2.68 ± 0.05 | 2.05 ± 0.05 |

Note:
The numerical values in this table are averages, and,
* refers to significant difference at p = 0.05 by T-tests (similarily hereinafter).

TABLE 5
Influence of the feed composition of the present
inventionon the immune organs of chicks

| Item | Control group | Test group |
|---|---|---|
| Thymus index (g/kg) | 3.87 ± 0.21 | 4.65 ± 0.92 * |
| Spleen index (g/kg) | 1.08 ± 0.09 | 1.48 ± 0.10 * |
| Bursal index (g/kg) | 3.16 ± 0.07 | 3.43 ± 0.02 * |

It can be seen from the data in Table 4 and Table 5 that, by using the formula feed for chickens provided by the present invention, the conversation rate of the feed is improved, and the survival rate of chicks is also greatly improved (the survival rate of the test group is nearly 8 percentage points higher than that of the control group, with a significant difference). In addition, the chicks in the test group have good growth conditions and higher weight gain.

It is also found during the feeding process that, the chicks in the test group have bright feather and high degree of health, and thus do not need to be injected with immune drugs; while the chicks in the control group have obviously worse feather and are likely to catch diseases, and thus need to be regularly injected with immune drugs for maintaining health during the experiment.

In addition, researches show that both the disease resistance and survival rate of chicks cannot be improved when any one of the raw materials in the component A is fed alone. However, in the present invention, when the component A as an active component is mixed with the component B to form formula feed for chickens, the components in the component A are mixed properly in proportion, so that the active constituents in each component are coordinated with each other to generate a balance between the nutrient substances; moreover, the active constituents are uniform in content, diverse, and significantly effective in increasing the survival rate of chicks. Consequently, no injection of immune drugs is required for chicks fed by the feed provided by the present invention, and thus, resistance to drugs, drug residues and other problems will be avoided.

The foregoing embodiments are merely preferred solutions of the present invention, and are not intended to limit the present invention in any form. Other variations and modifications may be further made without departing from the technical solutions defined by the claims.

1. Formula feed containing biogas residues for chickens, characterized in that the formula feed for chickens is prepared by mixing a component A and a component B, wherein the component A makes up 17%-37.5% of the total weight;
the component A is prepared by mixing the following raw materials in parts by weight:
20-50 parts of biogas residues,
15-28 parts of radix astragali residues,
3-6 parts of purple perilla,
4-8 parts of eucommia leaves,
3-8 parts of purslane, and
1-2 parts of premix;
the biogas residues are resulting products from anaerobic fermentation of distillers' grains left by using cassava or sweet potatoes as raw materials for fermentation, and are then moisture removed by mechanical extrusion, dried by exposure to the sun and finally crushed by a crusher for use;
the component B is prepared by mixing the following raw materials in parts by weight:
48-52 parts of corn,
10-12 parts of soybean meal,
1.2-1.5 parts of calcium hydrophosphate,
1.2-1.3 parts of rock flour, and
0.1-0.3 parts of salt.

2. The formula feed containing biogas residues for chickens according to claim 1, characterized in that the component A is prepared by mixing the following raw materials in parts by weight: 48 parts of biogas residues, 25 parts of radix astragali residues, 6 parts of purple perilla, 8 parts of eucommia leaves, 6 parts of purslane and 1 part of premix.

3. The formula feed containing biogas residues for chickens according to claim 1, characterized in that the component A is prepared by mixing the following raw materials in parts by weight: 37 parts of biogas residues, 28 parts of radix astragali residues, 4 parts of purple perilla, 6 parts of eucommia leaves, 8 parts of purslane and 1 part of premix.

4. A method for preparing formula feed containing biogas residues for chickens according to claim 1, comprising the following steps of:
a. mixing in proportion and then crushing the purple perilla, eucommia leaves and purslane, controlling the granularity below 10 mm, and baking or air-drying until the water content is lower than 12%;
b. mixing the mixture obtained in step a with the biogas residues, radix astragali residues and the premix to obtain the component A; and
c. mixing the component A with the component B in proportion to obtain the product.

5. The method for preparing formula feed containing biogas residues for chickens according to claim 4, further comprising the step of: drying, extruding and granulating the product.

6. An application of the formula feed containing biogas residues for chickens according to claim 1 in manufacturing feed for enhancing the immunity of poultry.
